(19) United States
(12) Patent Application Publication
(10) Pub. No.: US 2026/0091395 A1
(43) Pub. Date: Apr. 2, 2026

(54) LIQUID EXTRACTION SYSTEM

(71) Applicant: Honeywell International Inc., Charlotte, NC (US)

(72) Inventor: Bedros Nigoghosian, Phoenix, AZ (US)

(21) Appl. No.: 18/904,867

(22) Filed: Oct. 2, 2024

(51) Int. Cl. B03C 1/247

(52) U.S. Cl. CPC B03C 1/247; B03C 2201/20

(57) ABSTRACT

A liquid extraction system includes a housing, a liquid extraction assembly, and a motor. The liquid extraction assembly is configured to separate a liquid from particles that include magnetic particles, and includes a cylinder configured to receive the particles into an inner volume. The cylinder includes a porous wall that includes a non-ferrous conductive layer, and an anti-static layer configured to repel the particles. The motor is configured to cause the cylinder to rotate within the housing.

### TECHNICAL FIELD

The present disclosure relates to systems and techniques for liquid extraction.

### BACKGROUND

In resource-limited environments, such as outer space, water may be extracted from unconventional sources, including an atmosphere, fog, icebergs and glaciers, and other non-bulk liquid sources. For example, water may be extracted from soil through evaporation and condensation using a heat source or absorption using hydrogels or other absorbents. Such thermal or absorptive mechanisms may require large amounts of power or absorbent.

### SUMMARY

In general, the disclosure describes liquid extraction systems and methods for separating a liquid from magnetic, and optionally non-magnetic, particles, such as water from lunar particles. A volume of magnetic and non-magnetic particles may include a liquid that is frozen on or between the particles. A liquid extraction system includes a cylinder that receives particles into an inner volume and rotates within the housing. The cylinder includes a porous wall that includes a non-ferrous conductive layer that repels the magnetic particles and an anti-static layer that repels the non-magnetic particles. Rotation of the cylinder generates relative movement between the magnetic particles and the conductive layer to induce eddy currents that generate heat. The heat melts the frozen liquid to mobilize the liquid within the cylinder. The rotation of the cylinder further generates a centrifugal force to drive the liquid across the porous wall while containing the particles within the cylinder. In this way, liquids may be extracted from readily available particles using a low amount of power.

In some examples, the disclosure describes a liquid extraction system that includes a housing, a liquid extraction assembly, and a motor. The liquid extraction assembly is configured to separate a liquid from particles including magnetic particles, and includes a cylinder configured to receive the particles into an inner volume. The cylinder includes a porous wall that includes a non-ferrous conductive layer, and an anti-static layer. The motor is configured to cause the cylinder to rotate within the housing.

In some examples, the disclosure describes a method for extracting a liquid from particles that include magnetic particles that includes receiving, by a cylinder of a liquid extraction assembly, the particles into an inner volume of the cylinder. The method further includes rotating, by a motor, the cylinder within a housing to separate the liquid from the particles. The cylinder includes a porous wall that includes a non-ferrous conductive layer configured to repel the magnetic particles, and an anti-static layer configured to repel the non-magnetic particles.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a conceptual block diagram illustrating a liquid generation system that includes an example liquid extraction system.

FIG. 1B is a conceptual block diagram illustrating the example liquid extraction system of FIG. 1A.

FIG. 1C is a conceptual diagram illustrating separation of liquid from magnetic and non-magnetic particles.

FIG. 2A is a cross-sectional side view diagram illustrating an example liquid extraction system.

FIG. 2B is a cross-sectional side view diagram of a porous wall of a cylinder of the example liquid extraction system of FIG. 2A.

FIG. 2C is a cross-sectional side view diagram of a porous wall of a cylinder of the example liquid extraction system of FIG. 2A.

FIG. 3 is a flowchart of an example technique for separating a liquid from magnetic and non-magnetic particles.

### DETAILED DESCRIPTION

In general, the disclosure describes liquid extraction systems and methods for separating a liquid from magnetic, and in some instances non-magnetic, particles, such as water from lunar particles.

Naturally occurring particles, such as sand or dust, may include liquid that is frozen on or absorbed to the particles. For example, lunar soil may include lunar sand mixed with water in the form of ice up to about 500 parts per million (ppm), equivalent to about a 12 ounce bottle of water for a cubic meter of lunar soil. Parts of the moon, such as the lunar south pole, may potentially include large amounts of water due to low sun exposure and correspondingly low temperatures. However, such liquid may not be readily available without further processing, including phase transformation of a frozen solid to a liquid and subsequent separation of the liquid from the particles.

According to principles of the disclosure, liquid extraction systems described herein are configured to separate a liquid from magnetic particles, and optionally non-magnetic particles, by using magnetic properties of the magnetic particles. A liquid extraction system includes a vessel and a liquid extraction assembly. A liquid extraction assembly includes a cylinder that receives the particles into an inner volume and rotates within a housing. The cylinder includes a porous wall having a non-ferrous conductive layer and an anti-static layer. Rotation of the cylinder generates relative movement between the magnetic particles and the conductive layer to induce eddy currents in the conductive layer that generate heat in the conductive layer. The heat melts the frozen liquid to mobilize the liquid within the cylinder. The rotation of the cylinder further generates a centrifugal force to drive the liquid across the porous wall while containing the particles within the cylinder. The anti-static layer repels the particles from the porous wall to maintain open surface area of the porous wall for migration of the liquid. In this way, liquids may be extracted from readily available particles using a low amount of power.

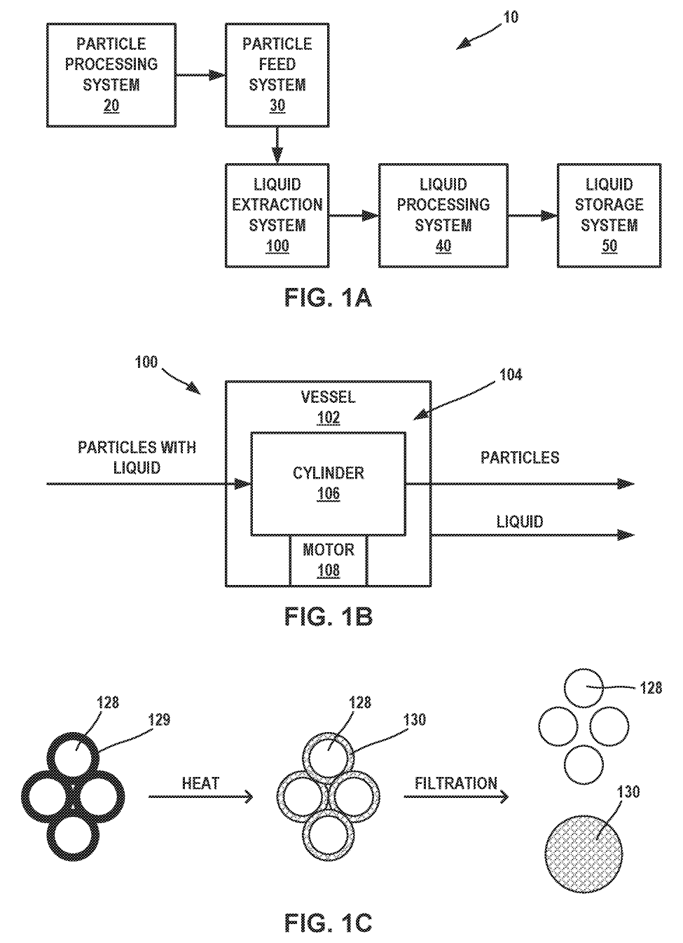

FIG. 1A is a conceptual block diagram illustrating a liquid generation system 10 that includes an example liquid extraction system 100. As will be described further below, liquid extraction system 100 is configured to separate liquid from particles that include magnetic particles. Upstream of liquid extraction system 100, liquid generation system 10 includes a particle processing system 20 and a particle feed system 30. Particle processing system 20 may be configured to process particles or agglomerations of particles into a form that may improve separation of the liquid. For example, particle processing system 20 may include equipment configured to reduce a size of the particles or agglomerations of the particles, such as a pulverized or crusher. Particle feed system 30 may be configured to feed particles to liquid extraction system 100. For example, particle feed system 30 may include a hopper, conveyer, or other mechanical system configured to deliver the particles to liquid extraction system 100. Downstream of liquid extraction system 100, liquid generations system 10 includes a liquid processing system 40 and a liquid storage system 50. Liquid processing system 40 may be configured to further processing the liquid separated from the particles, such as by filtration. Liquid storage system 50 may be configured to store the liquid. The particles may be stored for use or discarded.

FIG. 1B is a conceptual block diagram illustrating an example liquid extraction system 100 for separating a liquid from particles. Liquid extraction system 100 includes a vessel 102, a liquid extraction assembly 104, and a motor 108. Vessel 102 is configured to receive magnetic, and optionally non-magnetic, particles containing liquid in a substantially immobilized state. For example, the liquid may be frozen on or between the particles, or may be otherwise adhered to the particles in a manner that limits flow of the liquid on the surface of the particles. Vessel 102 is configured to discharge separated liquid and the partially and/or fully deliquefied particles, such as for storage or further processing.

Liquid extraction assembly 104 includes a cylinder 106. Cylinder 106 is configured to receive the particles into an inner volume and contain the particles as the particles move through the inner volume. For example, the particles may pass through the inner volume from a top of cylinder 106 to a bottom of cylinder 106 in a generally plug flow manner due to gravity and/or another force. Cylinder 106 includes a porous wall that includes a non-ferrous conductive layer and an anti-static layer radially inward of the non-ferrous conductive layer. The anti-static layer is configured to repel the particles, such that the particles do not stick to the porous wall during passage through the inner volume.

Liquid extraction assembly 104 is configured to separate at least a portion of the liquid on or between the particles from the particles. Motor 108 is configured to rotate cylinder 106, and cylinder 106 is configured to rotate within vessel 102 as the particles pass through the inner volume of cylinder 106. Both the bulk flow of the particles and the rotation of cylinder 106 creates relative movement between the magnetic particles and the conductive layer. This relative movement induces eddy currents in the conductive layer that generate heat in the conductive layer through resistive heating. The eddy currents caused by the passage of the magnetic particles and the rotation of cylinder 106 may be stronger than the eddy currents caused solely by the passage of the magnetic particles through the inner volume of cylinder 106.

FIG. 1C is a conceptual diagram illustrating separation of liquid 130 from magnetic particles 128 through thermal and filtration processes. Magnetic particles 128 may include frozen (or otherwise immobilized) liquid 129. The heat generated from the resistive heating mobilizes at least a portion of frozen liquid 129 on magnetic particles 128, and in some instances, may further transfer to non-magnetic particles. For example, for magnetic particles 128 that include frozen liquid 129, the resistive heat may melt at least a portion of the frozen liquid on the magnetic particles, such that the mobilized liquid 130 may flow in response to various forces.

In addition to increasing a strength of eddy currents, the rotation of cylinder 106 generates a centrifugal force to drive liquid 130 across the porous wall. For example, magnetic particles 128 may be drawn to the porous wall to contact with the anti-static layer on the porous wall. Liquid 130 on magnetic particles 128 may flow from magnetic particles 128 to the porous wall. Pores in the porous wall may permit liquid 130 to flow through the porous wall. The conductive layer may limit adhesion of magnetic particles 128 to the porous wall, while the anti-static layer may limit adhesion of magnetic particles and non-magnetic particles to the porous wall, such that the deliquefied particles may be removed from the inner volume and particles containing liquid may access the porous wall.

In some examples, the liquid includes water, and the particles include lunar sand. For example, in permanently shadowed regions near the lunar poles, water ice can be mixed with the lunar regolith in amounts sufficient for extraction to be economically viable, such as up to about 5–10 weight percent (wt. %) water. In such examples, the lunar regolith particles may pass through the inner volume of cylinder 106 to generate eddy currents in the conductive layer and, correspondingly, resistive heat in the inner volume. The resistive heat may melt the ice to form liquid water. The liquid water may migrate from surfaces of the lunar sand to a surface of the porous wall and pass through the porous wall. The lunar sand may have a relatively high electrostatic charge due solar winds, photoemission, and other environmental factors. Despite such electrostatic charge, the lunar sand may continue to fall through the inner volume due to the anti-static layer, and be removed from cylinder 106.

In this way, liquids may be extracted from readily available particles using a low amount of power. For example, liquid extraction system 100 may power motor 108, and in some instances a coil embedded in the porous wall, to generate both the eddy currents used to heat the particles and the centrifugal force used to drive the mobilized liquid across the porous wall. By utilizing magnetic properties of the magnetic particles, this power may be relatively low compared to other separation systems, such as thermal separation systems that involve external heating sources to evaporate and subsequently condense the liquid, or absorbent separation systems that involve external heating and sorbent regeneration to absorb and release the liquid. Additionally or alternatively, liquid extraction system 100 may be relatively small and/or lightweight compared to other such systems, enabling liquid extraction system 100 to be used in mobile environments.

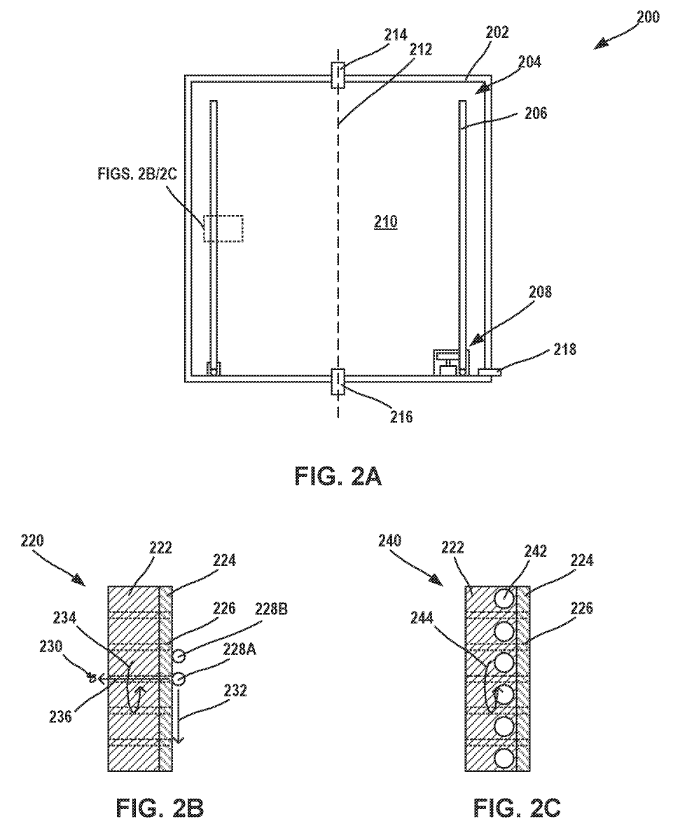

FIG. 2A is a cross-sectional side view diagram illustrating an example liquid extraction system 200. Liquid extraction system 200 includes a vessel 202, a liquid extraction assembly 204, and a motor 208. Vessel 202 is configured to define a controlled environment for heating and filtration of the particles and the liquid liberated from the particles. Vessel 202 includes a particle inlet 214 configured to receive particles, a particle outlet 216 configured to discharge deliquefied particles, and a liquid outlet 218 configured to discharge liquid liberated from the particles. While illustrated in the example of FIG. 2A and discharging to an atmosphere, in some examples, vessel 202 includes liquid storage systems, such as tanks, configured to receive the discharged separated liquid.

As described with respect to liquid extraction assembly 104 of FIG. 1A–C, liquid extraction assembly 204 is configured to separate a liquid from magnetic, and optionally non-magnetic, particles via thermal and rotational energy generated in combination with magnetic properties of the magnetic particles. Liquid extraction assembly 204 includes a cylinder 206 configured to receive the particles into an inner volume 210 and rotate within vessel 202 around an axis 212. Cylinder 206 may be configured for generally bulk flow from one end of cylinder 206 to the other. In the example of FIG. 2A, cylinder 206 is configured to receive the particles near a top of cylinder 206 and discharge the particles near a bottom of cylinder 206.

Dimensions of cylinder 206, including a diameter and length of cylinder 206, may be selected according to a desired flow rate and travel distance of the particles. As one example, an amount of resistive heat that is generated in cylinder 206 and transferred to the particles may be a function of the residence time of the magnetic particles in inner volume 210. As such, the length of cylinder 206 may be selected to provide an adequate residence time to the magnetic particles to heat and mobilize (e.g., melt) the liquid on the particles.

As another example, effects of the magnetic particles falling through cylinder 206 may differ primarily due to their positions relative to a center and wall cylinder 206. These differences may influence the induced eddy currents in terms of their distribution, strength, and the resultant magnetic and electric fields. For example, a magnetic particle falling near the porous wall may create an asymmetrical distribution of a magnetic field. The magnetic flux may be more pronounced near the porous wall where the magnetic particle is falling, thereby producing stronger eddy currents and resulting in a greater amount of heat generated. The closer proximity of the magnetic particle to the porous wall may also increase an amount of heat that is transferred from the heated porous wall to the magnetic particle. As such, a diameter of cylinder 206 may be selected to reduce an average distance of the magnetic particles from the porous wall while still enabling an adequate amount of inner volume 210 for accommodating a desired flow rate of the magnetic particles.

The porous wall of cylinder 206 includes pores or other voids configured to permit migration of liquids and contain the magnetic and non-magnetic particles. The pores (e.g., perforations, holes, or gaps) may be sized, in combination with repulsive effects of the conductive and anti-static layers, to exclude passage of particles while permitting passage of a liquid. The porous wall may include a variety of different configurations of a porous wall having pores including, but not limited to, a perforated wall having perforations, a mesh having holes, or an arrangement of parallel bars having gaps.

Motor 208 is configured to rotate cylinder 206. While illustrated in FIG. 2A as a peripheral wheel-driven motor, any of a variety of motors may be used to rotate cylinder 206, including an axle-driven motor or belt- or chain-driven motor. The rotation of cylinder 206 generates a centrifugal force to drive the liquid across the porous wall. A controller (not shown) may control a speed of motor 208, such as to achieve a desired revolutions per minute (RPM) of cylinder 206.

Cylinder 206 includes a porous wall. FIG. 2B is a cross-sectional side view diagram of a porous wall 220 of cylinder 206 of the example liquid extraction assembly 204 of FIG. 2A. Porous wall 220 includes a non-ferrous conductive layer 222 and an anti-static layer 224 overlying conductive layer 222.

Anti-static layer 224 is configured to repel magnetic particles 228A and non-magnetic particles 228B. Anti-static layer 224 may be configured to prevent build-up of static electricity and electrostatic discharge. For example, anti-static layer 224 may be sufficiently conductive to dissipate electrostatic charges to prevent the build-up of static electricity that attracts and holds magnetic and non-magnetic particles. A variety of anti-static materials may be used for anti-static layer 224 including, but not limited to, conductive polymers, metallic coatings, nanocomposites, and other conductive materials that may be applied to a surface of conductive layer 222. In some examples, anti-static layer 224 may also be configured to filter the liquid passing through the pores.

Non-ferrous conductive layer 222 is configured to generate eddy currents and resistively heat in response to the generated eddy currents. The generated heat may transfer to particles 228 directly or indirectly (via gas in inner volume 210) to heat particles 228. Properties for which conductive layer 222 may be selected may include, but are not limited to, electrical conductivity, thermal conductivity, and any other parameters associated with generating eddy currents or generating resistive heat from the induced eddy currents. A variety of non-ferrous conductive materials may be used in conductive layer 222 including, but not limited to, copper or aluminum.

Porous wall 220 includes a plurality of pores 226. Pores 226 may be configured to, in combination with repulsive effects of conductive layer 222 and anti-static layer 224, exclude passage of magnetic particles 228 while permitting passage of liquid 230. In some examples, porous wall 220 may be formed as a coated substrate, in which conductive layer 222 provides bulk properties and anti-static layer 224 provides surface properties. In such examples, conductive layer 222 includes pores 226, and anti-static layer 224 is present as a coating overlying conductive layer 222.

Motion 232 of magnetic particles 228A and rotation of cylinder 206 generates relative movement between magnetic particles 228A and conductive layer 222 to induce eddy currents 234 in conductive layer 222. These eddy currents 234 generate heat in conductive layer 222 to maintain porous wall 220 at a relatively high temperature. The relatively high temperature of porous wall 220 may heat particles 228 directly or via air in inner volume 210, eventually melting liquid 230 on particles 228. A centrifugal force 236 generated by rotation of cylinder 206 may drive liquid 230 through pores 226 to be removed from vessel 202 via liquid outlet 218.

In some examples, the porous wall of cylinder 206 may include additional structures that increase an amount of heat generated by magnetic particles 228A as magnetic particles 228A pass through inner volume 210. FIG. 2C is a cross-sectional side view diagram of a porous wall 240 of cylinder 206 of the example liquid extraction assembly 204 of FIG. 2A. In the example of FIG. 2C, conductive layer 222 further includes one or more conductive coils 242 configured to couple to an alternating current source. Conductive coils 242 are configured to generate a dynamic, time-varying magnetic field in response to an alternating current from the alternating current source. This time-varying magnetic field may induce additional eddy currents 244 in the cylinder 206. If the induced magnetic field from the coils is in phase with the magnetic field from falling magnetic particles 228A, the eddy currents may be enhanced, leading to increased generation of resistive heat. A controller (not shown) may control various parameters of the alternating current source, such as phase, frequency, and amplitude, to generate a magnetic field that is in phase with the magnetic field generated by magnetic particles 228A. A variety of materials may be used for conductive coils including, but not limited to, copper, silver, aluminum, and the like.

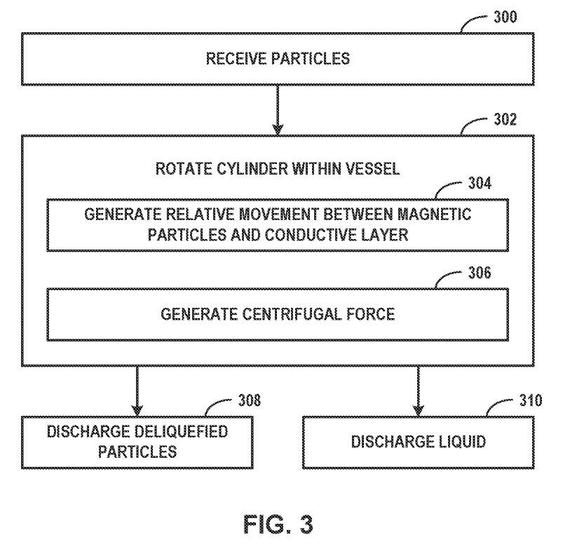

FIG. 3 is a flowchart of an example method for separating a liquid from magnetic particles. The example method of FIG. 3 will be described with respect to liquid extraction system 200 of FIG. 2A–2C; however, other liquid extraction systems may be used. The example method of FIG. 3 includes receiving, by cylinder 206 of liquid extraction assembly 204, the magnetic particles into inner volume 210 of cylinder 206 (300).

The example method of FIG. 3 includes rotating, by motor 208, cylinder 206 within vessel 202 to separate the liquid from the magnetic particles (302). The rotation of cylinder 206 generates relative movement between the magnetic particles and conductive layer 222 to induce eddy currents in conductive layer 222 that generate heat in conductive layer 222 (304). The generated heat transfer to particles 228 to heat particles 228 and liberate liquid 230. The rotation of cylinder 206 also generates a centrifugal force to drive liquid 230 across the porous wall. The rotation may be controlled to achieve a desired RPM of cylinder 206, such as may correspond to a desired amount of heat or centrifugal force generated by cylinder 206. In some examples, liquid 230 includes water, and particles 228 include lunar sand. The generated heat may melt ice on or between lunar sand particles. The generated centrifugal force may drive the water across the porous wall to be collected.

In some examples, such as for a liquid extraction system 200 that includes the porous wall 240 described in FIG. 2C, the method of FIG. 3 includes generating, by an alternating current source, an alternating current in one or more conductive coils to generate a dynamic magnetic field. The alternating current may be controlled to achieve a desired amount of heat generated by cylinder 206.

The example method of FIG. 3 includes discharging deliquefied particles 228 from vessel 202 (308). Such deliquefied particles may be discarded, or may be used for another process, such as a process for which relatively high surface area, deliquefied particles may be useful. The example method of FIG. 3 includes discharging liquid 230 (310), such as to storage or for further filtration or other processing.

Example 1: A liquid extraction system includes a vessel; and a liquid extraction assembly configured to separate a liquid from particles that include magnetic particles, wherein the liquid extraction system comprises a cylinder configured to receive the particles into an inner volume and rotate within the vessel, and wherein the cylinder comprises a porous wall includes a non-ferrous conductive layer; and an anti-static layer configured to repel the particles.

Example 2: The liquid extraction system of example 1, wherein the rotation of the cylinder generates relative movement between the magnetic particles and the non-ferrous conductive layer to induce eddy currents in the non-ferrous conductive layer that generate heat in the non-ferrous conductive layer.

Example 3: The liquid extraction system of any of examples 1 and 2, wherein the non-ferrous conductive layer further comprises one or more conductive coils configured to couple to an alternating current source.

Example 4: The liquid extraction system of example 3, wherein the one or more conductive coils are configured to generate a dynamic magnetic field in response to an alternating current from the alternating current source.

Example 5: The liquid extraction system of any of examples 1 through 4, wherein the non-ferrous conductive layer comprises at least one of copper or aluminum.

Example 6: The liquid extraction system of any of examples 1 through 5, wherein the rotation of the cylinder generates a centrifugal force to drive the liquid across the porous wall.

Example 7: The liquid extraction system of any of examples 1 through 6, wherein the porous wall comprises at least one of a perforated wall, a mesh, or an arrangement of parallel bars.

Example 8: The liquid extraction system of any of examples 1 through 7, wherein the particles include non-magnetic particles, wherein the anti-static layer is configured to repel the non-magnetic particles, and wherein the non-ferrous conductive layer is configured to repel the magnetic particles.

Example 9: The liquid extraction system of any of examples 1 through 8, wherein the non-ferrous conductive layer comprises a plurality of pores, and wherein the anti-static layer comprises a coating overlying the non-ferrous conductive layer.

Example 10: The liquid extraction system of any of examples 1 through 9, further comprising a motor configured to rotate the cylinder.

Example 11: The liquid extraction system of any of examples 1 through 10, wherein the cylinder is configured to: receive the particles near a top of the cylinder; and discharge the particles near a bottom of the cylinder.

Example 12: The liquid extraction system of any of examples 1 through 11, wherein the liquid comprises water, and wherein the particles comprise lunar sand.

Example 13: A method for extracting a liquid from particles that include magnetic particles includes receiving, by a cylinder of a liquid extraction assembly, the particles into an inner volume of the cylinder; and rotating, by a motor, the cylinder within a vessel to separate the liquid from the particles, wherein the cylinder includes a porous wall that includes: a non-ferrous conductive layer; and an anti-static layer that repels the particles.

Example 14: The method of example 13, wherein the rotation of the cylinder generates relative movement between the magnetic particles and the non-ferrous conductive layer to induce eddy currents in the non-ferrous conductive layer that generate heat in the non-ferrous conductive layer.

Example 15: The method of any of examples 13 and 14, wherein the non-ferrous conductive layer further comprises one or more conductive coils configured to couple to an alternating current source.

Example 16: The method of example 15, wherein, to separate the liquid from the particles, the one or more conductive coils generate a dynamic magnetic field in response to an alternating current from the alternating current source.

Example 17: The method of any of examples 13 through 16, wherein the rotation of the cylinder generates a centrifugal force to drive the liquid across the porous wall.

Example 18: The method of any of examples 13 through 17, wherein the particles include non-magnetic particles, wherein the anti-static layer repels the non-magnetic particles, and wherein the non-ferrous conductive layer repels the magnetic particles.

Example 19: The method of any of examples 13 through 18, wherein the particles are received near a top of the cylinder, and wherein the method further includes discharging, by the cylinder, the particles near a bottom of the cylinder.

Example 20: The method of any of examples 13 through 19, wherein the liquid comprises water, and wherein the particles comprise lunar sand.

Various examples have been described. These and other examples are within the scope of the following claims.

What is claimed is:

1. A liquid extraction system, comprising:
a vessel; and
a liquid extraction assembly configured to separate a liquid from particles that include magnetic particles, wherein the liquid extraction system comprises a cylinder configured to receive the particles into an inner volume and rotate within the vessel, and wherein the cylinder comprises a porous wall comprising:
a non-ferrous conductive layer; and
an anti-static layer configured to repel the particles.

2. The liquid extraction system of claim 1, wherein the rotation of the cylinder generates relative movement between the magnetic particles and the non-ferrous conductive layer to induce eddy currents in the non-ferrous conductive layer that generate heat in the non-ferrous conductive layer.

3. The liquid extraction system of claim 1, wherein the non-ferrous conductive layer further comprises one or more conductive coils configured to couple to an alternating current source.

4. The liquid extraction system of claim 3, wherein the one or more conductive coils are configured to generate a dynamic magnetic field in response to an alternating current from the alternating current source.

5. The liquid extraction system of claim 1, wherein the non-ferrous conductive layer comprises at least one of copper or aluminum.

6. The liquid extraction system of claim 1, wherein the rotation of the cylinder generates a centrifugal force to drive the liquid across the porous wall.

7. The liquid extraction system of claim 1, wherein the porous wall comprises at least one of a perforated wall, a mesh, or an arrangement of parallel bars.

8. The liquid extraction system of claim 1,
wherein the particles include non-magnetic particles,
wherein the anti-static layer is configured to repel the non-magnetic particles, and
wherein the non-ferrous conductive layer is configured to repel the magnetic particles.

9. The liquid extraction system of claim 1,
wherein the non-ferrous conductive layer comprises a plurality of pores, and
wherein the anti-static layer comprises a coating overlying the non-ferrous conductive layer.

10. The liquid extraction system of claim 1, further comprising a motor configured to rotate the cylinder.

11. The liquid extraction system of claim 1, wherein the cylinder is configured to:
receive the particles near a top of the cylinder; and
discharge the particles near a bottom of the cylinder.

12. The liquid extraction system of claim 1,
wherein the liquid comprises water, and
wherein the particles comprise lunar sand.

13. A method for extracting a liquid from particles that include magnetic particles, the method comprising:
receiving, by a cylinder of a liquid extraction assembly, the particles into an inner volume of the cylinder; and
rotating, by a motor, the cylinder within a vessel to separate the liquid from the particles, wherein the cylinder includes a porous wall that includes:
a non-ferrous conductive layer; and
an anti-static layer that repels the particles.

14. The method of claim 13, wherein the rotation of the cylinder generates relative movement between the magnetic particles and the non-ferrous conductive layer to induce eddy currents in the non-ferrous conductive layer that generate heat in the non-ferrous conductive layer.

15. The method of claim 13, wherein the non-ferrous conductive layer further comprises one or more conductive coils configured to couple to an alternating current source.

16. The method of claim 15, wherein, to separate the liquid from the particles, the one or more conductive coils generate a dynamic magnetic field in response to an alternating current from the alternating current source.

17. The method of claim 13, wherein the rotation of the cylinder generates a centrifugal force to drive the liquid across the porous wall.

18. The method of claim 13,
wherein the particles include non-magnetic particles,
wherein the anti-static layer repels the non-magnetic particles, and
wherein the non-ferrous conductive layer repels the magnetic particles.

19. The method of claim 13,
wherein the particles are received near a top of the cylinder, and
wherein the method further includes discharging, by the cylinder, the particles near a bottom of the cylinder.

20. The method of claim 13,
wherein the liquid comprises water, and
wherein the particles comprise lunar sand.
